(19) United States
(12) Patent Application Publication
(10) Pub. No.: US 2023/0150826 A1
(43) Pub. Date: May 18, 2023

(54) CLAY NANOPARTICLE PREPARATION FOR INDUSTRIAL APPLICATIONS

(71) Applicant: Saudi Arabian Oil Company, Dhahran (SA)

(72) Inventors: Mansour Ahmed Al-Shafei, Dhahran (SA); Tulay Inan, Dhahran (SA); Wala Ali Algozeeb, Dhahran (SA); Adel Mastoor Alsolami, Dhahran (SA); Shouwen Shen, Dhahran (SA)

(73) Assignee: Saudi Arabian Oil Company, Dhahran (SA)

(21) Appl. No.: 17/527,771

(22) Filed: Nov. 16, 2021

(51) Int. Cl. C01B 39/02; B01J 29/06

(52) U.S. Cl. CPC C01B 39/026; B01J 29/06

(57) ABSTRACT

A method of enriching nano-bentonite from a raw bentonite composition comprises the steps of mixing the raw bentonite composition with water to produce a bentonite solution, increasing the temperature of the bentonite solution to produce a warm bentonite solution, mixing the warm bentonite solution at a mixing rate to produce a colloidal solution, filtering the colloidal solution with a micro-sieve to produce a filtered colloidal solution, centrifuging the filtered colloidal solution at a centrifuge rate for a centrifuge time to produce a separated colloidal solution, wherein the nano-sized impurities are selected from the group consisting of quartz, feldspar, cristbalite, calcite, iron oxides, magnetite, calcium carbonate, and combinations of the same, and drying the separated colloidal solution to remove water to produce the nano-bentonite.

### BACKGROUND OF THE INVENTION

### Technical Field

Disclosed are methods for preparing nano-clays. More specifically, disclosed are methods and compositions for preparing nano-clays from bentonite.

### Description of the Related Art

Nano-clays are widely used in industry in many applications such as paint, water treatments, agriculture, oil productions and catalysis to support broad processes. In the oil processing industry, clays are used for various processes such as catalytic cracking, high severity fluid catalytic cracking, hydrocracking, alkylation, reforming, isomerization, and hydrogenation.

Current methods to produce nano-clays suffer from several drawbacks. First, these methods can generate significant waste, such as nitric and sulfuric acids in acidification processes. Second these methods can require high calcinations temperatures (>550° C.) which requires significant energy and specialized ovens to achieve.

### SUMMARY

Disclosed are methods for preparing nano-clays. More specifically, disclosed are methods and compositions for preparing nano-clays from bentonite.

In a first aspect, a method of enriching nano-bentonite from a raw bentonite composition is provided. The method includes the steps of mixing the raw bentonite composition with water to produce a bentonite solution, where the bentonite solution includes 2% solids and the raw bentonite composition includes impurities. Increasing the temperature of the bentonite solution to produce a warm bentonite solution, where the temperature of the warm bentonite solution is between 27° C. and 50° C., mixing the warm bentonite solution at a mixing rate to produce a colloidal solution that includes micro-sized impurities. Further including the steps of filtering the colloidal solution with a micro-sieve to produce a filtered colloidal solution, where the micro-sized impurities are trapped on the micro-sieve, where the micro-sized impurities are selected from the group consisting of quartz, feldspar, cristbalite, calcite, iron oxides, magnetite, calcium carbonate, and combinations of the same, where the filtered colloidal solution includes nano-sized impurities. Centrifuging the filtered colloidal solution at a centrifuge rate for a centrifuge time to produce a separated colloidal solution, where the nano-sized impurities in the filtered colloidal solution are separated in the centrifuge, where the nano-sized impurities are selected from the group consisting of quartz, feldspar, cristbalite, calcite, iron oxides, magnetite, calcium carbonate, and combinations of the same. And drying the separated colloidal solution to remove water to produce the nano-bentonite, where the drying step occurs at a temperature of 105° C.

In certain aspects, the method is in the absence of chemical separation. In certain aspects, the method is in the absence of chemical extraction. In certain aspects, the mixing rate is 800 cycles per minute. In certain aspects, the micro-sieve is 37 microns. In certain aspects, the centrifuge rate is 2000 cycles/minute. In certain aspects, the centrifuge time is five minutes. In certain aspects, the method further includes the step of producing a catalyst from the nano-bentonite.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is an XRD analysis of the produced nano-bentonite from the Example.

FIG. 2 is a low-intermediate magnification HAADF STEM image of a ceramic sphere.

FIG. 3 is an intermediate magnification HAADF STEM image of a ceramic sphere.

FIG. 4 is a low magnification TEM image of a ceramic sphere.

FIG. 5 is an intermediate magnification TEM image of a ceramic sphere.

FIG. 6 is a high-resolution TEM image of a ceramic sphere.

In the figures, similar components or features, or both, can have the same or similar reference label.

### DETAILED DESCRIPTION OF THE INVENTION

While methods and compositions will be described with several embodiments, it is understood that one of ordinary skill in the relevant art will appreciate that many examples, variations and alterations to the compositions and methods described here are within the scope and spirit of the embodiments. Accordingly, the embodiments described herein are set forth without any loss of generality, and without imposing limitations, on the embodiments.

The method of enriching nano-bentonite removes impurities and isolates nano-bentonite from the raw bentonite. Additionally, the method of enriching nano-bentonite reduces the size of the nano-bentonite recovered relative to the raw bentonite. Purifying the bentonite by removing impurities makes the nano-bentonite suitable for use as an industrial material. The nano-bentonite can be used in catalysts, such as high severity fluid catalytic cracking (HS-FCC) catalysts.

Advantageously, the method for enriching nano-bentonite can remove impurities and produce nano-bentonite without any chemicals. Advantageously, reducing the particles of bentonite to nano-bentonite can increase the surface area of the particles. Increasing the surface area can increase the chemical activity of the inorganic materials in the nano-bentonite.

In at least one embodiment, the method of enriching nano-bentonite could be used to remove contaminants and enrich montmorillonite. In at least one embodiment, the step of clay outcrops purification was carried out to remove all contaminants via precipitation technique.

A method of enriching nano-bentonite from raw bentonite composition is described. Enriching the nano-bentonite results in removal of impurities. Impurities can impact the physical and chemical properties of the raw bentonite, thus removing impurities can impact the properties of the clay.

The raw bentonite composition can be any type of material containing bentonite and impurities. The raw bentonite composition can be from any source. Advantageously, the raw bentonite composition can be locally sourced to reduce complexity due to transportation. The impurities can include quartz, feldspar, cristbalite, calcite, iron oxides, magnetite, calcium carbonate, and combinations of the same.

In a first step, the raw bentonite composition is mixed with water to produce a bentonite solution. The bentonite solution can contain 2 weight percent (wt %) of the raw bentonite composition in 1 L of distilled water and alternately greater than 2 wt % of the raw bentonite in 1L of distilled water. The water can be any source of water suitable for purifying a raw bentonite composition. In at least one embodiment, the water is a deionized water.

The temperature of the bentonite solution is increased to produce a warm bentonite solution. The temperature of the warm bentonite solution can be between 27° C. and 50° C. Advantageously, increasing the temperature of the bentonite solution increases the separation of the impurities from the raw bentonite. At temperatures less than 27° C., the impurities are not separated from the raw bentonite. At temperatures greater than 50° C., the bentonite skeleton can be destroyed.

The warm bentonite solution is mixed to produce a colloidal solution. The warm bentonite solution can be mixed at a mixing rate of 800 cycles per minute. The warm bentonite solution can be mixed from between 8 hours and 12 hours. Any type of mixer can be used to mix the warm bentonite solution. The impurities in the colloidal solution can be present as micro-sized impurities and nano-sized impurities. Micro-sized impurities are those less than 106 microns (μm).

The colloidal solution is filtered with a micro-sieve to produce a filtered colloidal solution. The size of the micro-sieve can be selected based on the size of the micro-sized impurities. In at least one embodiment, the micro-sieve can be in the range between 30 microns and 40 microns, and alternately between 35 microns and 40 microns. In at least one embodiment, the micro-sieve is 37 microns. Filtering the colloidal solution traps the micro-sized impurities on the micro-sieve. The liquids and nano-sized impurities pass through the micro-sieve to produce the filtered colloidal solution. The ratio of solids to solution in the filtered colloidal solution can be measured by drying a sample of the filtered colloidal solution at 105° C. In at least one embodiment, the sample of the filtered colloidal solution is 250 mL to 300 mL. The target ratio of solids to solution in the filtered colloidal solution is between 1.4 and 1.5. If the target ratio of solids to solution is greater than 1.5, the step of filtering colloidal solution with a micro-sieve is repeated. In at least one embodiment, the filtered colloidal solution is in the absence of micro-sized impurities.

The filtered colloidal solution is centrifuged to produce a separated colloidal solution. The step of centrifuging the filtered colloidal solution can occur at a centrifuge rate for a centrifuge time. The centrifuge rate is determined based on the ratio of solids to solution measured in the filtered colloidal solution. In at least one embodiment, the centrifuge rate is 2000 cycles/minute. In at least one embodiment, the centrifuge time is five minutes. Centrifuging the filtered colloidal solution separates wherein the nano-sized impurities in the filtered colloidal solution from the bentonite and the liquid. The nano-sized impurities are separated because they are lighter than bentonite and will stay in the solution layer. The bentonite because it is heavier stays separated during the centrifuging process.

In a final step, the water is removed from the separated colloidal solution by drying the separated colloidal solution. Drying can occur at a temperature of 105° C. The nano-bentonite remains after the water is removed. The average size of the nano-bentonite is about 10 nm.

The method of enriching nano-bentonite is in the absence of chemical separation process. The method of enriching nano-bentonite is in the absence of a chemical extraction process. The method of enriching nano-bentonite is the in the absence of an acid. The method of enriching nano-bentonite operates below 110° C.

### EXAMPLE

Example. Preparation and analysis was carried according to the method described. Characterization of the nano-bentonite solid product was performed using advanced analytical techniques such XRD, TEM, and STEM.

Raw bentonite was collected at a depth of 3 meters from Wadi Khulais, Saudi Arabia. In a first step, 120 grams of raw bentonite was added slowly (over 15-20 min) into 5880 gram of water in a 6 Liter glass reactor. The bentonite solution had a 2% solid/solution ratio. The temperature of the mixture was increased to 50° C. The warm bentonite solution was stirred for 40 minutes at 800 cycles/minute. After approximately 40 minutes colloidal solution formed.

The colloidal solution was filtered using 37 μm micro-sieve to remove impurities from the colloidal solution. The solid micro-sized impurities were retained on the micro-sieve. The filtered colloidal solution was under the micro-sieve. The ratio of solids to solution was checked to be within 1.5 to 1.4 by drying 250-300 ml of the filtered colloidal solution at 105° C.

The filtered colloidal solution was centrifuged at 2000 cycles/minute for 5 min. Finally, 200-250 ml of the separated colloidal solution was dried at 105° C. to produce the nano-bentonite for analysis. The yield of the nano-bentonite was calculated according to equation 1:

Yield=(weight of nano-bentonite/weight of raw bentonite)×100 (1)

The yield in this example was 1.5%.

XRD Analysis

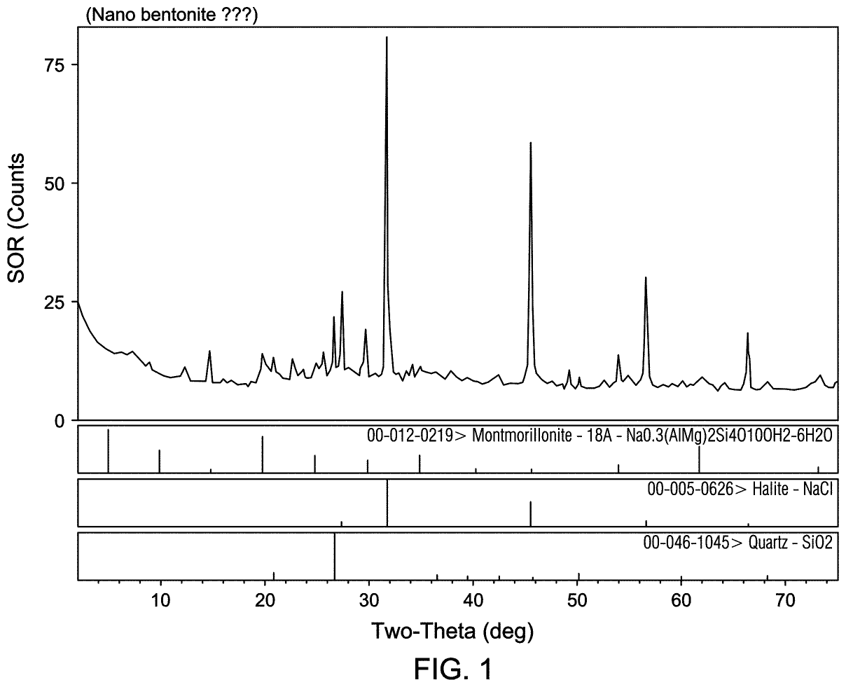

The x-ray powder diffraction (XRD) technique was used to analyze the purity of the nano-bentonite, including the presence of any impurities. The analysis was carried out by matching the XRD pattern of the produced nano-bentonite sample, as shown in FIG. 1, with the calculated pattern in the database from the International Center for Diffraction Data (ICDD) Powder Diffraction File. All crystallized phases present in the sample were identified using the search-match capabilities of XRD software JADE 9.1+ and the ICDD-PDF database. FIG. 1 also indicates the presence of impurities in the nano-bentonite. The impurities were composed of quartz-SiO₂ and halite-NaCl. Halite-NaCl was likely produced in the purification process and can be removed by washing the nano-bentonite with deionized water. The quartz-SiO₂ was present in the raw bentonite sample.

To calculate the crystallite size, Scherrer's equation was used:

Dv=kλ/βcos θ (2)

where Dv is the crystallite size weighted by volume; k is the Scherrer constant, assumes the crystals are spherical with cubic symmetry and takes the value of 0.9; λ is wavelength of X-ray radiation (Å), where the value is 1.5418 Å for a copper x-ray source); and β is the integral breadth of peak (in radians 2θ) located at angle 2θ, where usually full width at half maximum (FWHM) is used for the determination of the integral breadth of peak.

To determine the FWHM of the peak, the XRD software Jade 9.0+ was utilized to perform the XRD pattern profile fitting to calculate FWHM with different mathematic models of Pseudo-Voigt and Pearson VII. The results from Jade 9.0+ with the Pseudo-Voigt model were more accurate and stable. Using equation 2, the average crystallite size of the nano-bentonite was 10 nm.

TEM Analysis

A transmission electron microscopy (TEM) investigation was carried out, where a few ceramic spheres were embedded in epoxy resin bricks and glued using the M-Bond 610 resin. The as-obtained “spheres-sandwich” was polished mechanically to get a thin section 30-40 μm thick and then thinned up to the electron-transparency via ion-milling for the subsequent transmission electron microscopy (TEM) investigation.

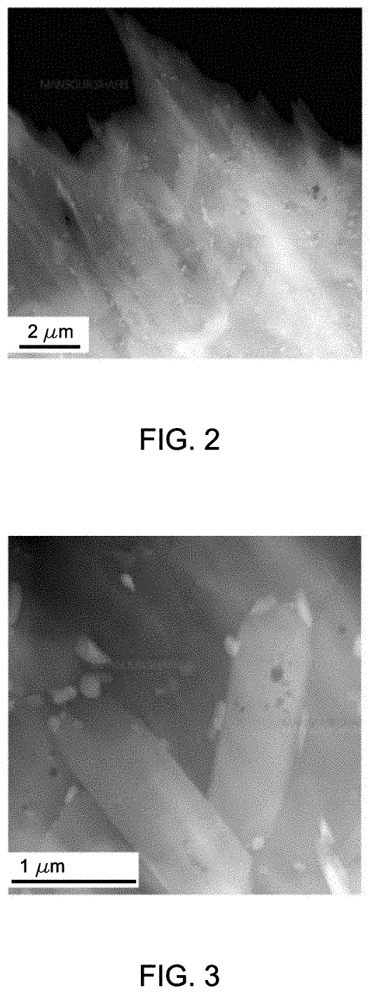

TEM and scanning TEM (STEM) investigations were preformed using FEI Titan CT microscope equipped with a field emission gun working at 300 kV. High angle annular dark field (HAADF) STEM imaging of the ceramic spheres reveals their polycrystalline structure. It is possible to discriminate two different phase generations according to their mutual growing relationship and localization. The ceramic is made mostly by a primary phase crystals characterized by an irregular morphology and size from a few hundreds of nm to a few of μm. These primary crystals were randomly oriented across the ceramic spheres and form well-developed and narrow grain boundaries. The low-intermediate magnification HAADF STEM image of the internal structure of a ceramic sphere is shown in FIG. 2, exhibiting the presence of irregular crystal and small globular crystals a few tens of nm wide with brighter electron contrast. The intermediate magnification HAADF STEM image showing the detail of irregular crystals forming narrow grain boundaries is shown in FIG. 3. FIG. 3 clearly shows that the small globular crystals grow preferentially at the interfaces of the irregular crystals and at their grain boundaries.

FIG. 3 also shows that a second phase occurred with a homogenous distribution across the ceramic. In addition, the ceramic crystals exhibited globular morphologies and sizes on the order of hundreds of nm. The ceramic spheres exhibited unlinked primary crystals, where the secondary crystals do not form proper grain-boundaries, because of their smaller size, but they grow preferentially at the interfaces of the primary crystals.

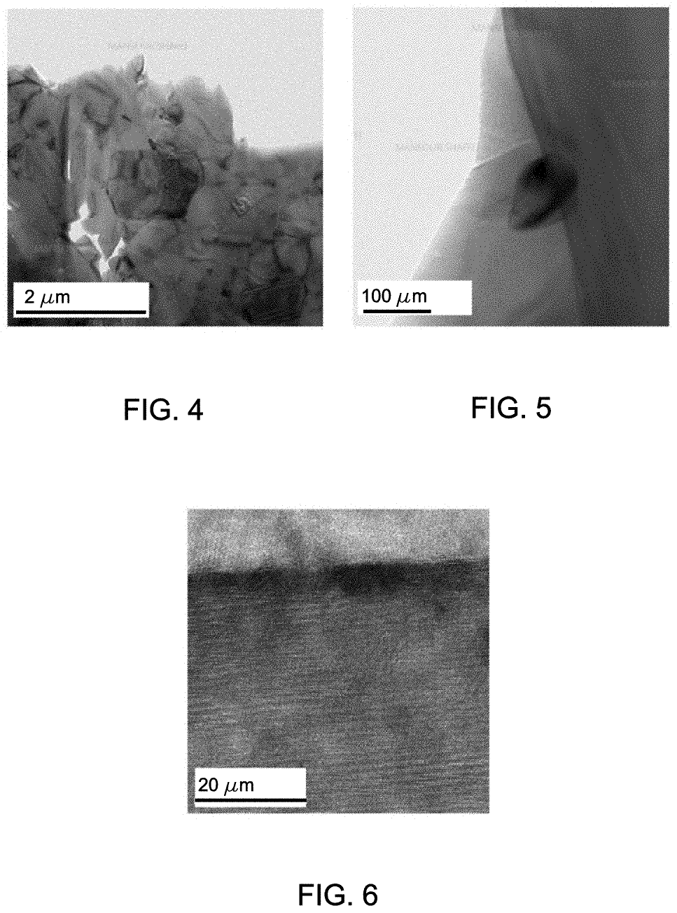

TEM imaging at low-intermediate magnification revealed more clearly the polycrystalline structure of the ceramic by showing the different crystallites with a random orientation, as seen in FIG. 4. In particular, the TEM image displayed the grain size distribution and the sharp grain-boundary interfaces of the spheres, see FIG. 5 and FIG. 6. The secondary crystals display their tendency to grow at the interface of the primary crystals showing no preferential orientation, as seen by the darker electron contrast of the secondary crystal in FIG. 5. FIG. 6 shows that the high-resolution TEM investigation of the primary crystals revealed the detail of their grain boundary interface characterized by the presence of dislocation fields. The primary crystals displayed a well-oriented irregular crystal with a flat and narrow grain-boundary interface.

Although the embodiments have been described in detail, it should be understood that various changes, substitutions, and alterations can be made hereupon without departing from the principle and scope. Accordingly, the scope of the embodiments should be determined by the following claims and their appropriate legal equivalents.

The singular forms “a,” “an,” and “the” include plural referents, unless the context clearly dictates otherwise.

Optional or optionally means that the subsequently described event or circumstances can or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

As used herein and in the appended claims, the words “comprise,” “has,” and “include” and all grammatical variations thereof are each intended to have an open, non-limiting meaning that does not exclude additional elements or steps.

What is claimed is:

1. A method of enriching nano-bentonite from a raw bentonite composition, the method comprising the steps of:
mixing the raw bentonite composition with water to produce a bentonite solution, wherein the bentonite solution comprises 2% solids, wherein the raw bentonite composition comprises impurities;
increasing the temperature of the bentonite solution to produce a warm bentonite solution, wherein the temperature of the warm bentonite solution is between 27° C. and 50° C.;
mixing the warm bentonite solution at a mixing rate to produce a colloidal solution, wherein the colloidal solution comprises micro-sized impurities;
filtering the colloidal solution with a micro-sieve to produce a filtered colloidal solution, wherein the micro-sized impurities are trapped on the micro-sieve, wherein the micro-sized impurities are selected from the group consisting of quartz, feldspar, cristbalite, calcite, iron oxides, magnetite, calcium carbonate, and combinations of the same, wherein the filtered colloidal solution comprises nano-sized impurities;
centrifuging the filtered colloidal solution at a centrifuge rate for a centrifuge time to produce a separated colloidal solution, wherein the nano-sized impurities in the filtered colloidal solution are separated in the centrifuge, wherein the nano-sized impurities are selected from the group consisting of quartz, feldspar, cristbalite, calcite, iron oxides, magnetite, calcium carbonate, and combinations of the same; and
drying the separated colloidal solution to remove water to produce the nano-bentonite, wherein the drying step occurs at a temperature of 105° C.

2. The method of claim 1, wherein the method is in the absence of chemical separation.

3. The method of claim 1, wherein the method is in the absence of chemical extraction.

4. The method of claim 1, wherein the mixing rate is 800 cycles per minute.

5. The method of claim 1, wherein the micro-sieve is 37 microns.

6. The method of claim 1, wherein the centrifuge rate is 2000 cycles/minute.

7. The method of claim 1, wherein the centrifuge time is five minutes.

8. The method of claim 1, further comprising the step of producing a catalyst from the nano-bentonite.
